(19) United States
(12) Patent Application Publication
(10) Pub. No.: US 2010/0136964 A1
(43) Pub. Date: Jun. 3, 2010

(54) Wireless Communication Terminal, Communication Control Method of Wireless Communication Terminal, and Wireless Communication System

(75) Inventor: Futoshi Ishihara, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto (JP)

(21) Appl. No.: 12/517,021

(22) PCT Filed: Nov. 29, 2007
(86) PCT No.: PCT/JP2007/073112

§ 371 Date: Sep. 11, 2009

(30) Foreign Application Priority Data
Nov. 29, 2006 (JP) 2006-322667

(51) Int. Cl. H04W 88/02; H04W 40/00

(52) U.S. Cl. 455/422.1; 455/550.1

(57) ABSTRACT

It is possible to provide a wireless communication terminal, a wireless communication terminal communication control method, and a wireless communication system, capable of effectively capturing a communication system, when a transmission operation is performed even if judgment of out-of-service-area is made. The wireless communication terminal (10) includes a control unit (18), a communication unit (11), and a storage unit (17). The control unit (18) stores in the storage unit (17) information specifying a communication system successfully acquired among a plurality of communication systems as a successful history. If a communication start is requested in the state judged to be an out-of-service-area state in which no communication can be performed, the communication system specified by the successful history is made to be an object to be acquired. If the acquisition fails, a communication system not specified by the successful history among a plurality of communication systems is made to be an object to be acquired. If the acquisition by the communication unit (11) is successful, a communication is started.

### TECHNICAL FIELD

The present invention relates to a wireless communication terminal, a communication control method of a wireless communication terminal, and a wireless communication system, which are applicable to, for example, a multiband compatible wireless communication system.

### BACKGROUND ART

A wireless communication terminal applied to CDMA (Code Division Multiple Access) communication starts a channel acquisition operation when sending or receiving a signal or when transferring data. Further, the wireless communication terminal obtains configuration information and timing information of the acquired channel and obtains position registration information etc. synchronized with the timing of the acquired channel.

In this regard, the received signal strength of the channel sometimes remarkably falls according to a usage environment of the wireless communication terminal (topography, buildings, etc.)

In a wireless communication terminal, when the received signal strength of the channel is low, regardless of the fact that the signal of the channel was received, it is judged that the channel could not be acquired and restitute processing is shifted to. In this restitute processing, the wireless communication terminal runs a system scan where the terminal acquires a channel by a predetermined cycle.

When the wireless communication terminal is out of the area, the wireless communication terminal internally turns a flag showing it is “out-of-service-area” (out-of-service-area flag) ON. In such a situation, even if the user performs a send operation, the terminal will not start up the send processing since the possibility of transmission is low while the out-of-service-area flag is ON and for saving power.

Further, once a terminal is judged “out-of-service-area”, the restitute acquisition processing is carried out by a predetermined cycle, but the communication schemes for running a system scan for reset are limited and the time required for restitute can no longer be ignored.

For example, consider a case where a wireless communication terminal is placed in a metal coin-operated locker or the like. A metal coin-operated locker etc. becomes “out-of-service-area” inside due to being surrounded by a signal barrier, but is excellent as a signal environment outside.

When the usage environment around the wireless communication terminal is extremely different in this way, for example, desirably a restitute operation should be performed immediately after taking the terminal out of the coin-operated locker. However, immediate reset is not possible unless at the timing of a restitute acquisition operation, therefore, a short while will end up being taken until communication becomes possible.

Further, if the restitute acquisition processing is carried out by a shorter cycle, the restitute is carried out fast. However, the power consumption ends up increasing at the time of out-of-service-area operation. Further, even if the restitute acquisition processing is carried out, the restitute takes a long time as well unless the target for acquisition can be specified with a high efficiency.

In order to overcome the problem described above, there is known the art of performing a channel acquisition operation if performing a send operation even when the terminal is judged “out-of-service-area” (see, for example, Patent Document 1).

Patent Document 1: Japanese Patent Publication (A) No. 2003-23665

### DISCLOSURE OF THE INVENTION

### Problems to be Solved by the Invention

According to the art disclosed in the above Patent Document 1, the call success rate can be improved even in a state judged “out-of-service-area”.

In this regard, recently, it has become possible for one wireless communication terminal to use a plurality of frequency bands (for example, 800 MHz and 2 GHz). Further, wireless communication terminals able to handle a plurality of communication protocols (CDMA2000 1x, EVDO) have been increasing.

Under such a situation, with just restitute acquisition processing of a plurality of channels for a single communication system, the signal will not necessarily be sent by the communication scheme desired by the user.

The present invention provides a wireless communication terminal, a communication control method of a wireless communication terminal, and a wireless communication system, which efficiently perform acquisition of a communication system and which can achieve connection by the communication scheme desired by the user as much as possible when the wireless communication terminal performs a send operation even in a state judged “out-of-service-area”.

### Means for Solving the Problems

A wireless communication terminal of a first aspect of the present invention has: a communication part capable of capturing a plurality of communication systems and capable of executing communication by a communication protocol, a control part which controls communication by the communication part by any of the plurality of communication systems using the communication protocol when the start of communication is instructed, and a memory part, in which, the memory part stores information specifying a successfully acquired communication system among the plurality of communication systems as a success history, and the control part performs a trial acquisition by the communication part using the communication system specified in the success history as a target for acquisition when a start of communication is requested in a state judged as an “out-of-service-area” state where the communication cannot be carried out, performs a trial acquisition by the communication part using a communication system not specified in the success history among the plurality of communication systems as the target for acquisition where the trial acquisition fails, and starts the communication when the trial acquisition by the communication part succeeds.

Preferably, the memory part stores a plurality of cases of information specifying communication systems successfully acquired by the communication part in an order of successful acquisition as the success history, and the control part sequentially determines the communication systems specified in the success history as the target for acquisition from the newest one when making the communication part execute a trial acquisition based on the success history.

Preferably, the control part has a communication system selection part instructing the communication part of a communication system to be acquired, a protocol execution part instructing the communication part of acquisition by the communication protocol, and an acquisition instruction function execution part instructing the communication system selection part of a start of trial acquisition processing of the communication system, and the acquisition instruction function execution part makes the communication system selection part select a communication system which does not exist in the success history among the plurality of communication systems and makes the protocol execution part instruct the acquisition of the selected communication system when the start of communication is requested in a state judged as an “out-of-service-area” state and the trial acquisition of the communication system specified by the information stored in the success history fails.

Preferably, the control part stores several cases as the success history in an order of successful acquisition for communication systems successfully acquired by the communication part, and the communication system selection part sequentially selects communication systems specified by the success history from the newest one when selecting the target for acquisition based on the success history.

Preferably, the communication protocol includes: a first communication protocol and a second communication protocol, in which, the protocol execution part includes a first protocol execution part instructing the communication part of acquisition by the first communication protocol and a second protocol execution part instructing the communication part of acquisition by the second communication protocol with a lower degree of priority for the trial acquisition processing than the first communication protocol, and the acquisition instruction function execution part makes the first protocol execution part instruct the acquisition of the selected communication system and makes the communication system selection part select the communication system based on the success history when the start of communication is requested in the state “out-of-service-area”, while makes the communication system selection part select the communication system based on the success history and makes the second protocol execution part instruct the acquisition of the selected communication system when the trial acquisition of the communication system based on the success history by the first protocol execution part fails.

Preferably, the acquisition instruction function execution part makes the communication system selection part select a communication system not specified by the success history among the plurality of communication systems and makes the first protocol execution part instruct the acquisition of the selected communication system when the start of the communication is requested in the out-of-service-area state and both of the first protocol execution part and the second protocol execution part fail in the trial acquisition of the communication system selected based on the success history and makes the communication system selection part select the communication system based on the success history and makes the second protocol execution part instruct the acquisition of the selected communication system when the trial acquisition of the communication system not specified by the success history by the first protocol execution part fails.

Preferably, the memory part stores the information showing the successfully acquired communication system and information showing by which of the first protocol execution part or second protocol execution part the acquisition was successful when storing the success history, and the acquisition instruction function execution part makes the communication system selection part select the communication system successfully acquired by the first protocol execution part and makes the first protocol execution part instruct the acquisition when the start of the communication is requested in the “out-of-service-area” state and the communication system is to be selected based on the success history by the communication system selection part and makes the communication system selection part select the communication system successfully acquired by the second protocol execution part and makes the second protocol execution part instruct the acquisition of the selected communication system when the trial acquisition fails for the selected communication system.

A second aspect of the present invention is a communication control method of a wireless communication terminal having: a communication part capable of capturing a plurality of communication systems and capable of executing communication by a communication protocol; and a memory part, and controlling the communication by the communication part by any of the plurality of communication systems using the communication protocol when the start of communication is instructed, the method including: a step of storing information specifying a successfully acquired communication system among the plurality of communication systems as the success history in the memory part; a step of having the communication part perform a trial acquisition using the communication system specified by the success history as the target for acquisition when the start of communication is requested in a state judged as “out-of-service-area” where communication cannot be carried out; a step of having the communication part perform the trial acquisition using a communication system not specified by the success history among the plurality of communication systems as the target for acquisition where the trial acquisition fails; and a step of starting the communication when the trial acquisition by the communication part succeeds.

A wireless communication system of a third aspect of the present invention includes a base station and a wireless communication terminal performing wireless communication with the base station through a channel assigned by the base station, wherein the wireless communication terminal has a communication part capable of capturing a plurality of communication systems and capable of executing communication according to a communication protocol, a control part which controls communication by the communication part by any of the plurality of communication systems using the communication protocol when a start of communication is instructed, and a memory part, the memory part stores information specifying a successfully acquired communication system among the plurality of communication systems as the success history, and the control part performs the trial acquisition by the communication part using the communication system specified by the success history as the target for acquisition when the start of communication is instructed in the state judged as the “out-of-service-area” state where the communication cannot be carried out, performs the trial acquisition by the communication part using a communication system not specified by the success history among the plurality of communication systems as the target for acquisition when the trial acquisition fails, and starts the communication when the trial acquisition by the communication part succeeds.

### EFFECTS OF THE INVENTION

According to the present invention, even in a state judged “out-of-service-area”, a communication system is more efficiently acquired when a send operation is carried out, so connection according to the communication scheme desired by the user can be achieved as much as possible.

### BRIEF DESCRIPTION OF THE DRAWINGS

FIG. 1 is a view of a system configuration showing a wireless communication system to which a wireless communication terminal according to an embodiment of the present invention is applied.

FIG. 2 is a flow chart for explaining a first send processing of a multiband compatible wireless communication terminal.

FIG. 3 is a block diagram showing an example of the configuration of a signal processing system of a wireless communication terminal according to the embodiment of the present invention.

FIG. 4A and FIG. 4B are diagrams showing an example of data structure of a scan list storage part used in the wireless communication terminal according to the embodiment of the present invention.

FIG. 5 is a perspective view showing an example of the configuration of an outer appearance of a mobile phone, as a mobile terminal device according to the embodiment of the present invention.

FIG. 6 is a first flow chart cited for explaining an operation (second send processing) of the wireless communication terminal according to the embodiment of the present invention.

FIG. 7 is a second flow chart cited for explaining an operation (second send processing) of the wireless communication terminal according to the embodiment of the present invention.

### EXPLANATION OF NOTATIONS

1 . . . wireless communication system, 10 . . . wireless communication terminal, 11 . . . communication part, 12 . . . operation part, 13 . . . call voice processing part, 14 . . . speaker, 15 . . . microphone, 16 . . . display part, 16 . . . memory part, 18 . . . control part, 181, 181 . . . key detection part, 182 . . . display control part, 183 . . . EVDO protocol execution part (first protocol execution part), 184 . . . 1x protocol execution part (second protocol execution part), 185 . . . communication system selection part, 186 . . . acquisition instruction function execution part, and 187 . . . scan list storage part.

### BEST MODE FOR CARRYING OUT THE INVENTION

Below, an embodiment of the present invention will be explained with reference to the attached drawings.

First, a communication system to which a wireless communication terminal according to an embodiment of the present invention can be applied will be explained.

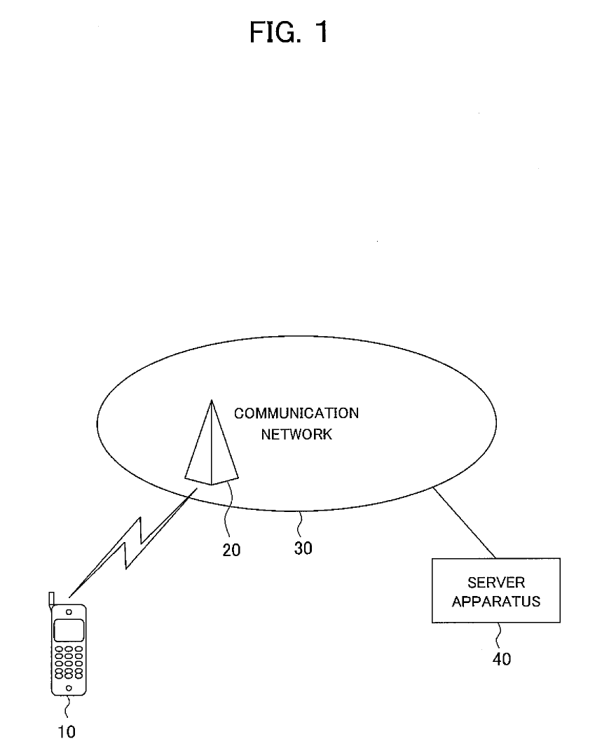

FIG. 1 is a view of the system configuration showing a wireless communication system to which a wireless communication terminal according to an embodiment of the present invention is applied.

A wireless communication system 1 is, as shown in FIG. 1, configured by a wireless communication terminal 10, base station 20, communication network 30, and server apparatus 40.

The wireless communication terminal 10 according to the present embodiment, as shown in FIG. 1, has a function of using the wireless communication part to request desired data via the base station 20 and through the communication network 30 to the server apparatus 40 and displaying Web data or other information obtained via the base station 20 in response to the request on the display part.

Note that, in the present embodiment, the explanation will be given illustrating a mobile phone as the wireless communication terminal. Note that, in the present embodiment, while the explanation is given illustrating a mobile phone as the wireless communication terminal, the embodiment can be applied to other wireless communication terminals as well.

In this regard, in recent years, in the wireless communication system 1, effective utilization of frequency bands used has been promoted. Reorganization of frequency bands has been studied for making the used frequency bands match with specifications of countries other than Japan as well.

For example, in a wireless communication system using CDMA2000 1x, at present, in Japan, the Japanese specification 800 MHz band (hereinafter referred to as “the present 800 MHz band”) is being used. There are plans for reorganizing this frequency band to a new 800 MHz band of the global standards and specifications.

Note that, the present 800 MHz band and the new 800 MHz band differ in allocation of the frequency bands used for uplink (communication from the wireless communication terminal 10 to the base station 20 side) and downlink (communication from the base station 20 side to the wireless communication terminal 10) etc.

In view of this background, multiband compatible wireless communication terminals capable of communication by the existing frequency band (present 800 MHz) and new frequency band (new 800 MHz) are being developed. Further, wireless communication terminals capable of communication even by a higher frequency band (2 GHz) in addition to these frequency bands are being developed as well.

The multiband compatible wireless communication terminal 10 engages in wireless communication with the base station 20 through the channel assigned by this base station 20. At this time, the wireless communication terminal 10 can transmit and receive wireless signals by a plurality of frequency bands. Specifically, an example is shown in which the wireless communication terminal 10 can transmit and receive wireless signals by using the existing frequency band (present 800 MHz), new frequency band (new 800 MHz), and high frequency band (2 GHz).

The above communication systems using different frequency bands are assigned “band classes” prescribed by the 3GPP2 (3rd Generation Partnership Project 2) as identification numbers for the base station 20 and the wireless communication terminal 10 to identify the frequency bands.

For example, in a list of nearby base stations etc. in information informed from the base station 20 to the wireless communication terminal 10, these band classes are used for reporting the communication systems existing around the wireless communication terminal 10 and so on.

Note that, the existing frequency band (present 800 MHz band) is classified as the “band class 3”, the new frequency band (new 800 MHz band) is classified as the “band class 0”, and the high frequency band (2 GHz band) is classified as the “band class 6”.

Further, each band class is assigned a primary channel and a secondary channel (note, only the primary channel in the EVDO communication of the band class 6).

Further, when considering the difference of protocols (EVDO), a total of 11 patterns of communication systems end up existing in Japan.

Below, the first send processing of the multiband compatible wireless communication terminal having the 11 patterns of communication systems described above will be explained.

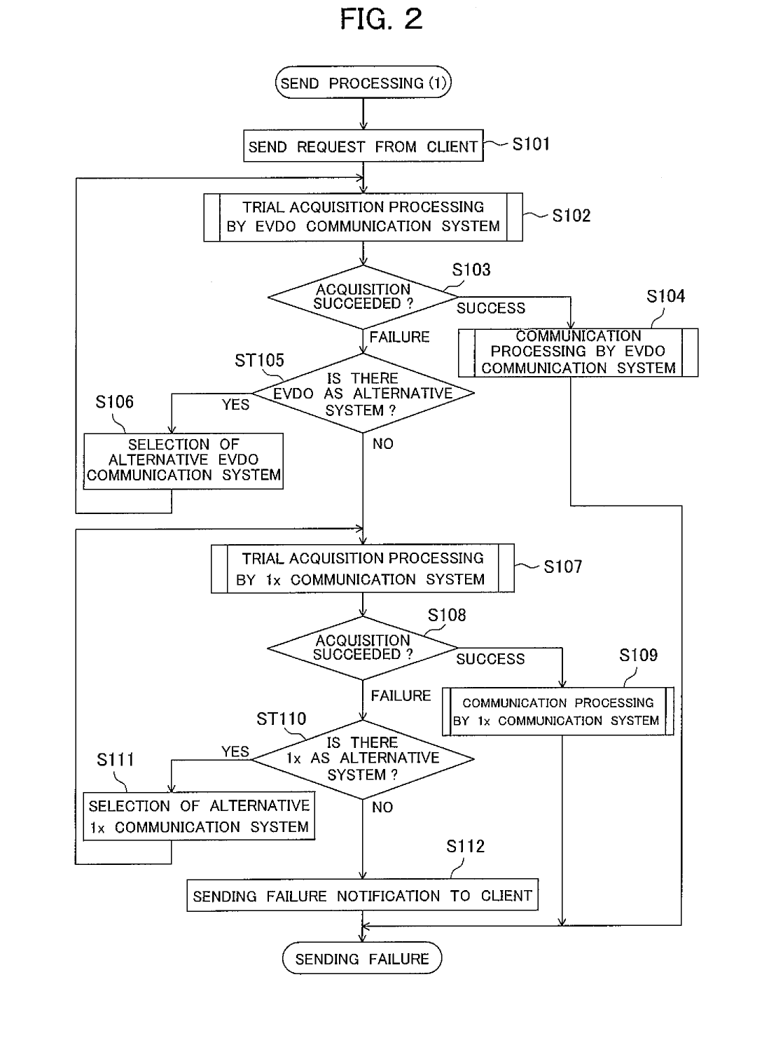

FIG. 2 is a flow chart for explaining the first send processing (1) of the multiband compatible wireless communication terminal.

Below, the first send processing of the multiband compatible wireless communication terminal will be explained with reference to FIG. 2.

When there is a send request for start of data communication by a user operation etc., the wireless communication terminal 10 selects and performs EVDO communication faster than the CDAMA2000 1x communication (hereinafter, simply referred to as “1x”) with a higher priority.

The wireless communication terminal 10 performs the trial acquisition processing of the communication system when accepting a send request. When failing in the acquisition of the first communication system, the wireless communication terminal 10 searches for an alternative communication system for which the trial acquisition processing must be executed next from a list storing information for all communication systems which can be acquired by the wireless communication terminal (band class/frequency, primary/secondary channel identifier, 1x/EVDO protocol identifier, used channel specifying code etc.), that is, a PRL (Preferred Roaming List). However, at this time, the alternative EVDO communication system is selected with a higher priority and retransmission is carried out. When the send operation in all alternative EVDO communication systems fails, the wireless communication terminal 10 selects the 1x communication system in the PRL and executes the trial acquisition processing by the retransmission.

Specifically, as shown in FIG. 2, by the user operation or when a send request is detected from the application (S101), the wireless communication terminal 10 selects an EVDO communication system stored in the PRL and executes the trial acquisition processing by the EVDO communication system selected here (S102).

Here, when the acquisition succeeds (S103 “Yes”), the wireless communication terminal executes the send processing by using the successful EVDO communication system (S104). When the acquisition fails (S103 “No”), the wireless communication terminal 10 judges whether or not there is an alternative EVDO communication system with reference to the PRL again (S105). Here, where there is an alternative EVDO communication system (S105 “Yes”), the wireless communication terminal 10 selects that alternative EVDO communication system and executes the trial acquisition processing of S102 and on (S106).

On the other hand, when the trial acquisition processing of all communication systems of the alternative EVDO communication systems is executed and the processing fails in all (S105 “No”), the wireless communication terminal 10 executes the trial acquisition processing by the 1x communication system stored in the PRL at first (S107).

Here, when the acquisition succeeds (S108 “Yes”), the wireless communication terminal 10 executes the send processing by using the successfully acquired 1x communication system (S109). When the acquisition fails (S108 “No”), the wireless communication terminal 10 judges whether or not there is an alternative 1x communication system again with reference to the PRL (S110).

Here, when there is an alternative 1x communication system (S110 “Yes”), the wireless communication terminal selects that alternative 1x communication system and executes the trial acquisition processing of S107 and on (S111). Then, when the wireless communication terminal executes trial acquisition processing of all communication systems by the alternative 1x communication systems and the processing fails in all (S110 “NO”), the terminal informs the failure of sending (S112).

Note that, the above send processing is restricted in its duration. The send processing itself is ended unless the trial acquisition processing succeeds in a predetermined time. For example, if the communication with the base station is impossible even when the send operation is continued for 40 seconds, the sending ends up being automatically ended.

According to the first send processing (1) of the wireless communication terminal described above, all EVDO communication systems are subjected to the trial acquisition processing with a higher priority than all 1x communication systems. For this reason, even an EVDO communication system which has not been successfully acquired and has a low possibility of success of acquire executes the trial acquisition processing earlier than the 1x communication system which has been successfully acquired and is considered to have a high possibility of success of acquisition.

For this reason, in a state where actually no EVDO communication system is successfully acquired due to the “out-of-service-area” state etc., the time from the send request up to the trial acquisition processing by the 1x communication system after passing through the trial acquisition processing in all EVDO communication systems becomes long. In a state where the sending succeeds only in the 1x communication system, the opportunity for sending is lost, and there is a possibility that the usability will be lowered.

Further, in a case where a time restriction is provided for continuing the send processing from the start of sending or other case, the time runs out before the trial acquisition processing by the 1x communication system is completed, so there is a possibility of the sending success rate falling.

For this reason, in a second send processing (2) which will be explained below, by constructing a mechanism selecting a communication system considered to have a high sending success rate with a higher priority irrespective of whether it is the 1x communication system or the EVDO communication system, the duration from the send request to the success of sending is shortened and the opportunity for sending is increased, whereby the usability is improved, the sending success rate is raised by previously selecting the communication system considered to have a high sending success rate even in a case where the duration for continuing the trial sending operation from the start of sending is restricted, and further improvement of the usability is achieved.

Below, the configuration and operation of the wireless communication terminal capable of executing the second send processing will be explained in detail.

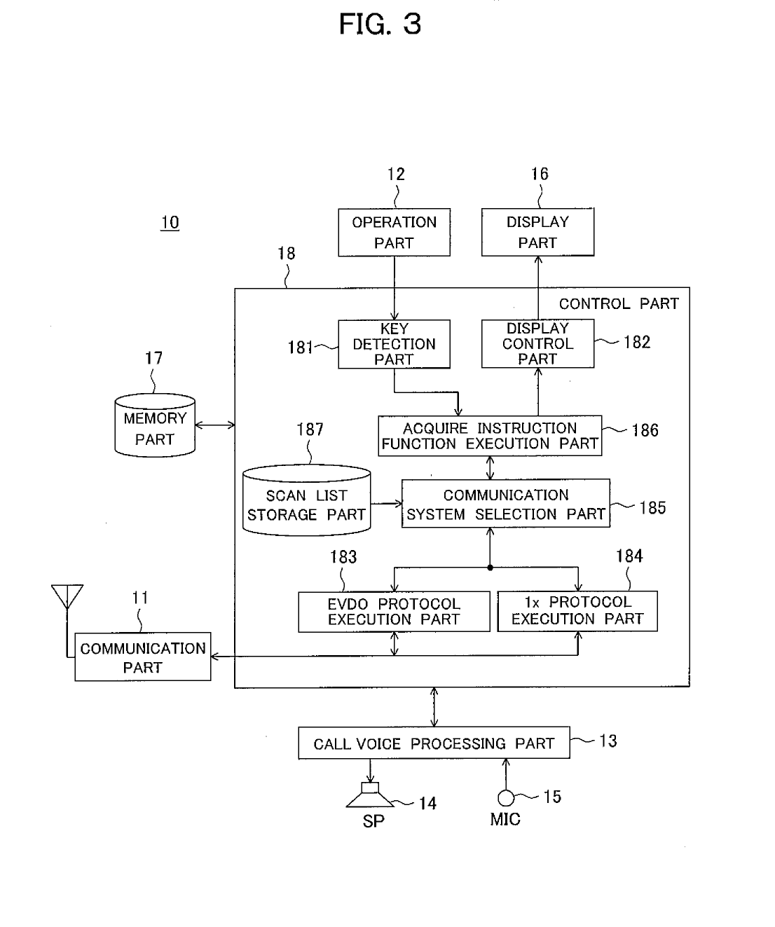

FIG. 3 is a block diagram showing an example of the configuration of a signal processing system of a wireless communication terminal according to an embodiment of the present invention capable of executing the second send processing described above.

Here, as described above, functional blocks of a signal processing system in a mobile phone constituting the wireless communication terminal 10 are illustrated.

This wireless communication terminal 10 constituted by a mobile phone has a communication part 11, operation part 12, call voice processing part 13, speaker (SP) 14, microphone (MIC) 15, display part 16, memory part 17, and control part 18.

The communication part 11 acquires a plurality of communication systems and wirelessly communicates with the base station 20 connected to a communication network 30 according to the first communication protocol (for example EVDO) and the second communication protocol (for example 1x). Note that, the EVDO communication is faster than 1x communication. The 1x communication has the feature that audio communication is also supported in addition to data communication unlike with EVDO communication.

Characteristically, when any of communication systems can be acquired under the control of the control part 18 which will be explained later, the communication part 11 stores this acquired communication system as the success history (MRU: Most Recently Used).

The communication part 11 has the function of executing the trial acquisition processing of the communication system stored as the success history when the trial acquisition processing is instructed and executing the trial acquisition processing of a communication system which does not exist in the success history when the trial acquisition processing fails. Details will be explained later.

The operation part 12 has, for example, a power key, speak key, number keys, letter keys, direction keys, an execute key, a send key, and other keys to which various functions are assigned. When these keys are operated by the user, the operation part 12 generates signals corresponding to those operation contents and inputs these as an instruction of the user to the control part 18.

The call voice processing part 13 performs the processing of the audio (voice) signal output from the speaker 14 and audio signal input at the microphone 15.

Namely, the call voice processing part 13 amplifies audio (voice) input from the microphone 15, performs analog-to-digital conversion, further applies encoding or other signal processing to this signal to convert the same to digital audio data, and outputs the result to the control part 18.

Further, the speech processing part 13 applies decoding, digital-to-analog conversion, amplification, or other signal processing to the audio data supplied from the control part 18 to convert the data to an analog audio signal and outputs the result to the speaker 14.

The display part 16 is configured by using, for example, a liquid crystal display panel, an organic EL (Electro-Luminescence) panel, or other display device and displays an image in accordance with a video signal supplied from the control part 18.

The display part 16 displays, for example, a phone number of a destination at the time of a send operation, a phone number of the other party at the time of the reception, contents of received mail and transmitted mail, the date, time, remaining battery power, success of a send operation, a standby screen, and other various information and images.

The memory part 17 stores various types of data utilized for the processing in the control part 18.

The memory part 17 holds, for example, programs of a computer provided in the control part 18, an address book for managing personal information such as phone numbers and e-mail addresses of other parties, an audio (voice) file for playing back an incoming call sound and an alarm sound, an image file for the standby screen, various types of setting data, temporary data utilized in the processing process of the programs, and so on.

Note that, the above memory part 17 is configured by, for example, a nonvolatile memory device (nonvolatile semiconductor memory, hard disc device, optical disc device, etc.), a random accessible memory device (for example, SRAM or DRAM), or the like.

The control part 18 centrally controls the entire operation of the mobile phone.

Namely, the control part 18 controls operations of blocks explained above (transmission/reception of signals at the communication part 11, input/output of audio at the call voice processing part 13, display of an image in the display part 16, and so on) so that various types of processing of the mobile phone (speech carried out through a line exchange network, preparation and transmission/reception of e-mails, viewing of Internet Web (World Wide Web) sites, and so on) are executed in a suitable sequence in accordance with the operation of the operation part 12.

The control part 18 is provided with a computer (microprocessor) executing processing based on a program (operating system, application program, etc.) stored in the memory part 17 and runs the processing explained above according to the sequence instructed in this program.

Namely, the control part 18 sequentially reads command codes from the operating system, application program, or other program stored in the memory part 17 to execute the processing.

Characteristically, the control part 18 has the function of issuing an acquisition instruction instructing the communication part 11 to acquire any of a plurality of communication systems when the start of communication is requested in a state judged as the “out-of-service-area” state when the mobile phone cannot communicate.

Below, a more concrete configuration and function of the control part 18 will be explained.

The control part 18 is, as shown in FIG. 3, configured by a key detection part 181, display control part 182, EVDO protocol execution part 183, 1x protocol execution part 184, communication system selection part 185, acquire instruction function execution part 186, and scan list storage part 187.

Note that, the functions of these blocks are achieved by the control part 18 executing programs stored in the memory part 17. Only blocks substantially differentiated from other blocks and built-in the control part 18 are not pointed out. Processing parts are separately expressed only for simplification of explanation.

The key detection part 181 has the function of detecting a send operation from the operation part 12 and activating the acquisition processing by the acquisition instruction function execution part 186. Further, the display control part 182 has a function of displaying success of sending output through the acquisition instruction function execution part 186 on the display part 16. Each performs a role as a user interface.

The EVDO protocol execution part 183 functions as a first protocol execution part instructing the communication part 11 of acquisition by the first communication protocol (EVDO).

Further, the 1x protocol execution part 184 functions as a second protocol execution part instructing the communication part 11 of acquisition by the second communication protocol (1x).

The EVDO protocol execution part 183 and the 1x protocol execution part 184 having such functions execute communications with the base station 20.

The communication system selection part 185 has a function of instructing the communication part 11 of a communication system to be acquired.

Specifically, when the start of the trial acquisition processing is instructed from the acquisition instruction function execution part 186 and the trial acquisition processing is carried out in response to this instruction, the communication system selection part 185 stores the communication system as the success history in the scan list storage part 187 when any of communication systems can be acquired.

Here, in the success history, information specifying not only the newest communication system which was successfully acquired, but also a plurality of communication systems in an FIFO manner (band class/frequency, primary/secondary channel identifier, 1x/EVDO protocol identifier, used channel specifying code etc.) are stored as the MRU explained before in the order of success.

Further, the MRU is stored for specifying the next used channel or the like in a communication area at a time when it is detected that the signal strength of the communication system being used becomes weak and a hand-over is carried out and so on.

After that, when the trial acquisition processing is instructed in a state where the “out-of-service-area” state where communication cannot be carried out is shifted to, the communication system selection part 185 executes the trial acquisition processing of the communication system stored as the success history in the scan list storage part 187. When it fails in the trial acquisition processing, the communication system selection part executes the trial acquisition processing of a communication system which does not exist in the success history.

Note that, the processing for updating the MRU is always being carried out. Therefore, substantially the newest success history up to immediately before the shift to the “out-of-service-area” ends up being stored.

In this regard, the “out-of-service-area state” in the embodiment of the present invention indicates the state where no signal having a strength capable of communication can be detected from any of the communication systems any longer and the out-of-service-area flag is turned ON, that is, a state where acquisition processing for the restitute is separately intermittently executed and the “in-area” state cannot be reset to and the out-of-service-area flag turned OFF.

The restitute processing is carried out at a predetermined period. Therefore, even when the surrounding signal environment has changed to a good state, the state judged as the “out-of-service-area” state ends up being continued in the period in which the restitute processing is not carried out.

Further, the control part 18 displays an antenna symbol on the display part 16 showing the state of the received signal based on the signal strength from the communication system during acquisition by the communication part 11. In the “out-of-service-area” state, this antenna symbol is notified to the user as the display showing “out-of-service-area” as well.

The acquisition instruction function execution part 186 has the function of instructing the communication system selection part 185 of the start of the trial acquisition processing of the communication system.

Specifically, when the start of communication is requested in the state judged as the “out-of-service-area” state where the communication cannot be carried out, the acquisition instruction function execution part 186 sends a trial acquisition processing start instruction instructing the acquisition of any of a plurality of communication systems to the communication system selection part 185.

When a predetermined time has passed before the success of acquisition is notified for this trial acquisition processing start instruction, the acquisition instruction function execution part 186 instructs the communication system selection part 185 of the start of the trial acquisition processing again.

Further, when the success of acquisition is notified for that trial acquisition processing start instruction, the acquisition instruction function execution part 186 performs the processing of the start of communication by the successfully acquired communication system.

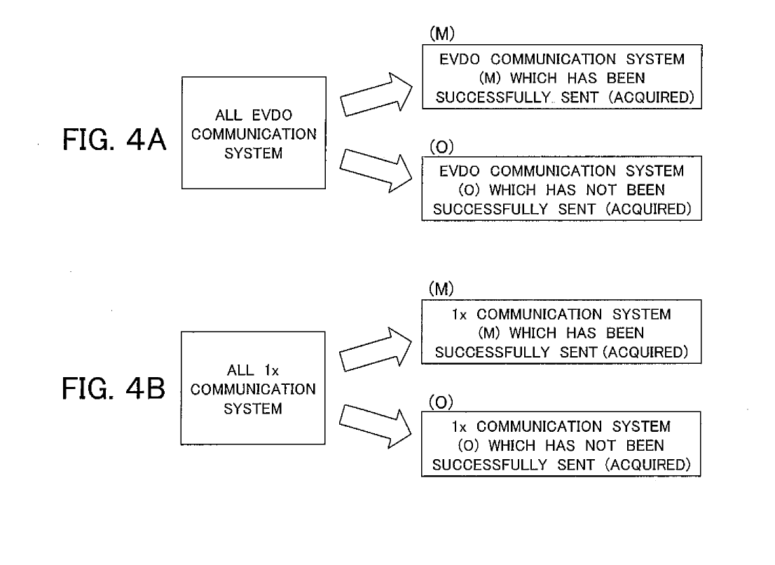

FIG. 4A and FIG. 4B are diagrams showing an example of the data structure of the scan list storage part used in the wireless communication terminal according to the embodiment of the present invention.

First, here, a PRL is used as the scan list.

The PRL stores a plurality of communication systems linked with the EVDO and 1x. The EVDO and 1x are data defined in an order so that with EVDO, EVDO is given priority, priority is given in an order of 2 GHz, new 800 MHz, and the present 800 MHz among the plurality of communication systems, and further a primary channel is selected with priority over a secondary channel.

As shown in FIG. 4A and FIG. 4B, the scan list storage part 187 stores a plurality of the EVDO communication systems and 1x communication systems in the PRL. Further, the scan list storage part 187 stores these divided into communication systems (M) which have succeeded in trial acquisition processing as the success history (communication systems matching with communication systems specified by information stored in the MRU) and communication systems (O) which have not succeeded in trial acquisition processing (communication systems not stored in the information specified in the MRU).

Namely, a communication system on the PRL matching with a communication system specified by information stored in the MRU (band class/frequency, primary/secondary channel identifier, 1x/EVDO protocol identifier, etc.) is extracted as the communication system (M), and a communication system which does not match is defined as the communication system (O).

Further, the communication systems (M) are stored in an order corresponding to the order of storage in the MRU, while the communication systems (O) hold the order of storage on the PRL in a form excluding communication systems stored in the MRU.

Below, among the EVDO communication systems, the former will be referred to as the EVDO(M) and the latter will be referred to as the EVDO(O), while among the 1x communication systems, the former will be referred to as the 1x(M) and the latter will be referred to as the 1x(O).

Note that, the scan list storage part 187 is assigned to a predetermined memory region of the memory part 17 when the power is turned on and is selected by the communication system selection part 185. At each trial acquisition processing executed between the EVDO protocol execution part 183 or the 1x protocol execution part 184 and the base station 20, the communication system which is successfully acquired or the communication system which fails to be acquired is stored together as history in the form of a list.

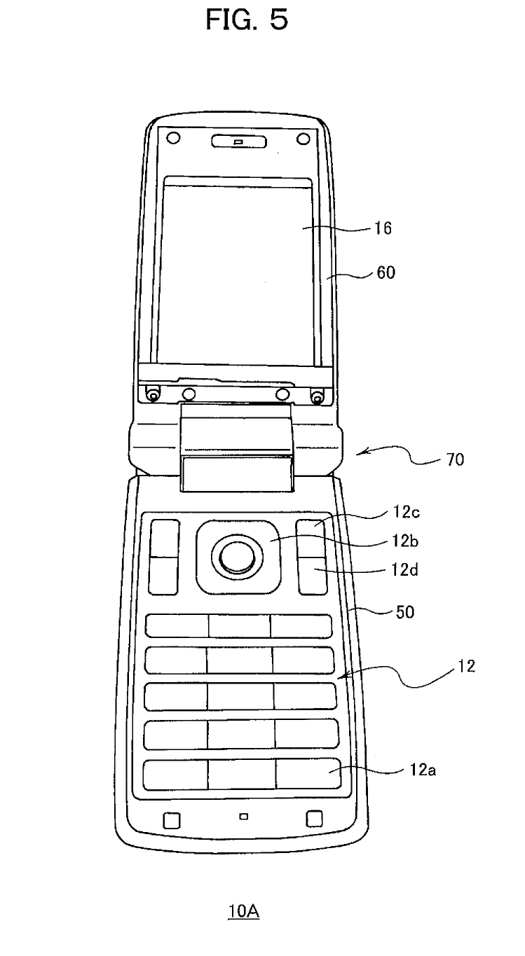

FIG. 5 is a perspective view showing an example of the configuration of an outer appearance of a mobile phone used as a mobile terminal device according to an embodiment of the present invention. FIG. 5 mainly shows the array of keys.

As shown in FIG. 5, a mobile terminal device 10A is configured as a so-called flip-open type mobile phone and is provided with a sender case 50 and a receiver case 60 which are connected to each other pivotably between an open state and a closed state.

The sender case 50 and the receiver case 60 form a housing of the mobile terminal device as a whole by connection of end portions by a connection part 70 serving as the center axis of relative opening and closing operations.

The sender case 50 is provided with an operation input part 12 in which various types of keys are arranged exposed at the front surface. Further, the receiver case 60 is provided with a display part 16.

In the operation input part 12 of the sender case 50, as various types of keys, for example, a tenkey part 12a, a cursor key 12b, function keys 12c, etc. are arranged.

The keys of the tenkey part 12a described above are assigned pluralities of characters such as Sino-Japanese ideographs, alphanumerics, phonetic kana marks, and symbols.

The effective characters intended by the tenkey part 12a are switched by a toggle operation by an “input mode change key (identification key)” assigned to any of the function keys 12c.

Any of these keys, for example, a function key 12c, is assigned as the operation key for sending a send instruction etc.

Note that, this operation key may be assigned to a not shown side key as well which is arranged on a side surface of the sender case.

Next, an example of operation according to the second send processing of the wireless communication terminal 10 of FIG. 3 will be explained.

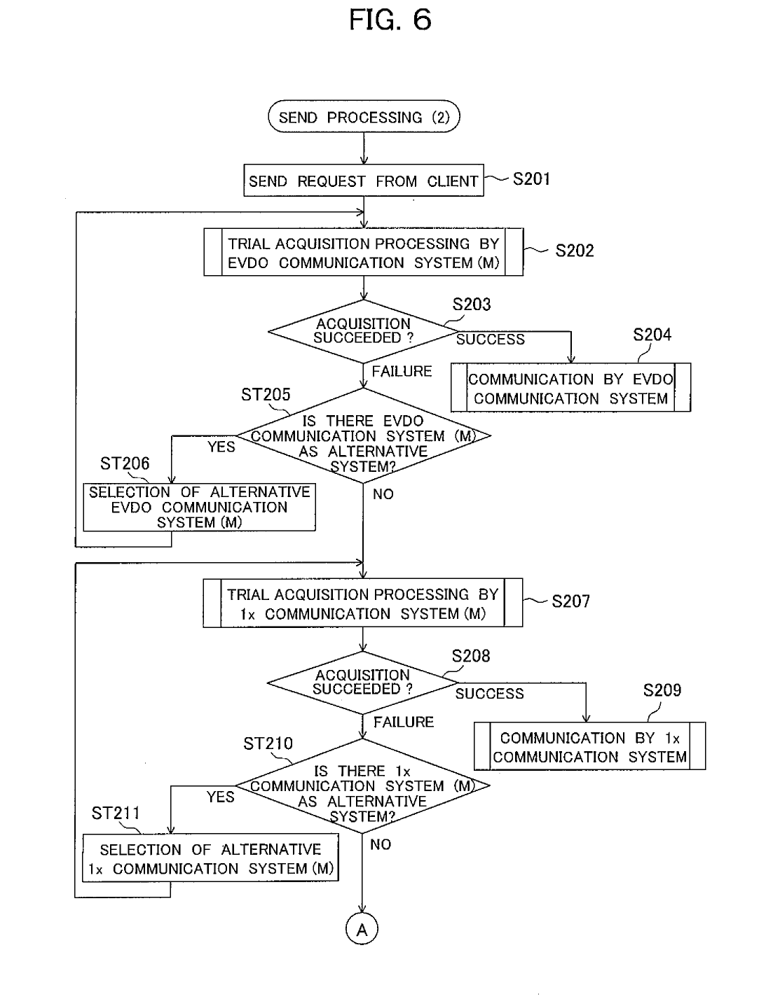

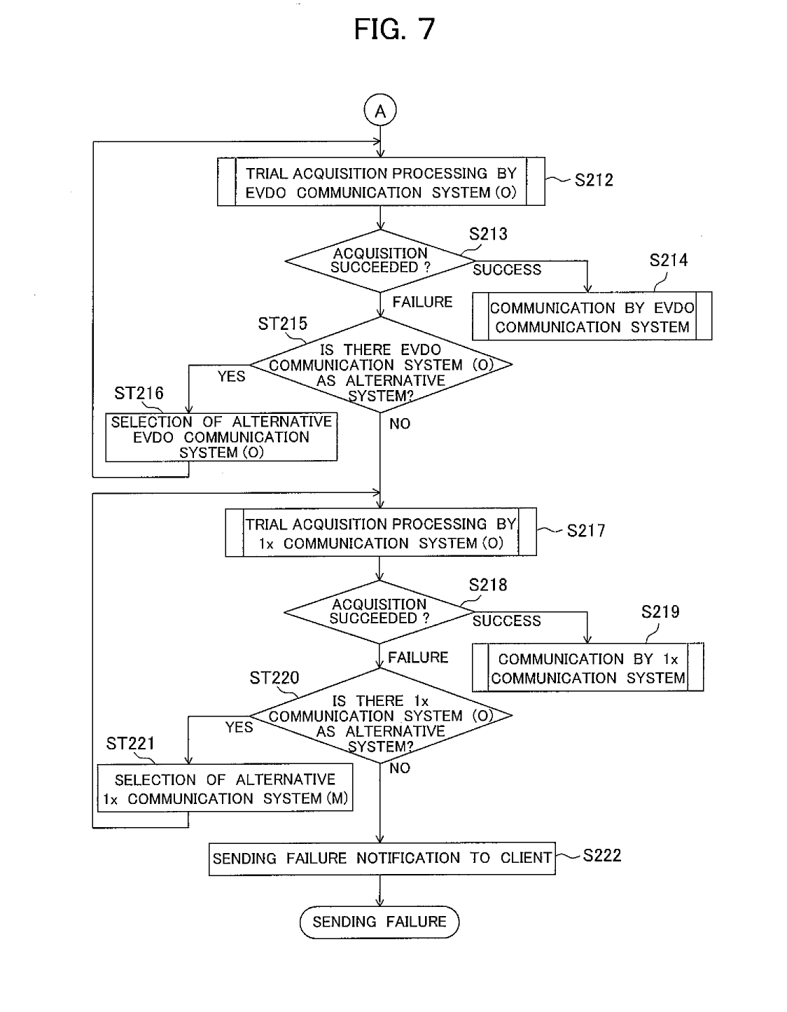

FIG. 6 and FIG. 7 are flow charts cited for explaining the processing sequence of the second send processing (2) by the wireless communication terminal according to the embodiment of the present invention.

Below, the second send processing (2) by the wireless communication terminal shown in FIG. 3 will be described in detail with reference to the flow charts shown in FIG. 6 and FIG. 7.

First, by the user operating the send key through the operation part 12, the send request is generated. This send request is detected by the key detection part 181. Due to this, the acquisition instruction function execution part 186 is activated (S201 of FIG. 6).

Here, the acquisition instruction function execution part 186 instructs the communication system selection part 185 of the start of the trial acquisition processing by an EVDO(M) (S202).

The communication system selection part 185 selects the newest EVDO(M) among the communication systems stored in the scan list storage part 187 upon receipt of an instruction of start of the trial acquisition processing, instructs the EVDO protocol execution part 183 of an acquisition so as to make the EVDO protocol execution part execute the acquisition by the EVDO communication system selected here, and waits for notification showing whether the acquisition is possible (S203).

The EVDO protocol execution part 183 executes the trial acquisition processing by the EVDO communication system with the base station 20 and notifies the result of whether the acquisition is possible to the communication system selection part 185. When the success of acquisition is notified (S203 “success”), the communication system selection part 185 requests the send processing using the successfully acquired EVDO(M) to the acquisition instruction function execution part 186. The acquisition instruction function execution part 186 receiving this send processing request executes the send processing (S204).

On the other hand, when the acquisition fails (S203 “failure”), the communication system selection part 185 judges whether or not there is an alternative EVDO(M) (if there is a communication system of EVDO stored in MRU) again with reference to the scan list storage part 187 (S205).

Here, when it is judged that there is an alternative EVDO(M) (S205 “Yes”), the communication system selection part 185 selects that alternative EVDO communication system (S206). Then, the communication system selection part 185 instructs the EVDO protocol execution part 183 of acquisition so as to execute acquisition by the EVDO communication system selected here and waits for the notification of whether the acquisition is possible.

The EVDO protocol execution part 183 executes the trial acquisition processing by the EVDO communication system with the base station 20 and notifies the result of whether the acquisition is possible to the communication system selection part 185.

The processing of the example described above is repeated (S202 to S206) to execute the trial acquisition processing of all communication systems of the alternative EVDO(M)'s stored in the scan list storage part 187. When this trial acquisition processing fails in all (S205 “No”), the acquisition instruction function execution part 186 receiving the notification, of failure from the communication system selection part 185 instructs the communication system selection part 185 of the start of the trial acquisition processing by an 1x(M) stored in the scan list storage part 187 (S207).

The communication system selection part 185 receives the instruction of start of the trial acquisition processing, selects an 1x(M) stored in the scan list storage part 187, instructs the 1x protocol execution part 184 of acquisition so as to execute the acquisition by the 1x communication system selected here, and waits for the notification of whether the acquisition is possible (S208).

The 1x protocol execution part 184 executes the trial acquisition processing by the selected 1x(M) with the base station 20 and notifies the result of whether the acquisition is possible to the communication system selection part 185. When the success of acquisition is notified (S208 “success”), the communication system selection part 185 activates the acquisition instruction function execution part 186 whereby the acquisition instruction function execution part 186 execute the send processing using the successfully acquired 1x communication system (S209).

On the other hand, when the acquisition fails (S208 “failure”), the communication system selection part 185 judges whether or not there is an alternative 1x(M) again with reference to the scan list storage part 187 (S210).

Here, where it is judged there is an alternative 1x communication system (S210 “Yes”), the communication system selection part 185 selects that alternative 1x communication system (S211), returns to the processing of S207, instructs the 1x protocol execution part 184 of acquisition so as to execute the acquisition by the 1x communication system selected here, and waits for the notification of whether the acquisition is possible (S208).

The 1x protocol execution part 184 executes the trial acquisition processing by the selected 1x communication system with the base station 20 and notifies the result of whether the acquisition is possible to the communication system selection part 185.

The processing of the example described above is repeated (S207 to S211) whereby the trial acquisition processing of all communication systems of alternative 1x(M)s stored in the scan list storage part 187 is executed. When the acquisition fails in all (S210 “No”), the acquisition instruction function execution part 186 receiving the notification of failure from the communication system selection part 185 instructs the communication system selection part 185 of the start of the trial acquisition processing by the EVDO(O) stored in the scan list storage part 187 (S212 of FIG. 6).

The communication system selection part 185 receives this, selects an EVDO(O) stored in the scan list storage part 187, instructs the EVDO protocol execution part 183 of acquisition for making it execute the acquisition by the EVDO communication system selected here, and waits for the notification of whether the acquisition is possible (S213).

The EVDO protocol execution part 183 executes the trial acquisition processing by the selected EVDO communication system with the base station 20 and notifies the result of whether the acquisition is possible to the communication system selection part 185. When acquisition success is notified (S213 “success”), the communication system selection part 185 activates the acquisition instruction function execution part 186 and the acquisition instruction function execution part 186 executes the send processing using the successfully acquired EVDO communication system (S214).

On the other hand, when it fails (S213 “failure”), the communication system selection part 185 judges whether or not there is an alternative EVDO(O) again with reference to the scan list storage part 187 (S215).

Here, where there is an alternative EVDO communication system (S215 “Yes”), the communication system selection part 185 selects that alternative EVDO communication system (S216). Then, the communication system selection part 185 instructs the EVDO protocol execution part 183 of acquisition for making it execute the acquisition by the EVDO communication system selected here and waits for the notification of whether the acquisition is possible (S213).

Next, the EVDO protocol execution part 183 executes the trial acquisition processing by the selected EVDO communication system with the base station 20 and notifies the result of whether the acquisition is possible to the communication system selection part 185.

The processing of the example described above is repeated (S212 to S216) to execute the trial acquisition processing of all communication systems of the alternative EVDO(O)s stored in the scan list storage part 187. When acquisition fails in all (S215 “No”), the acquisition instruction function execution part 186 which received the notification of failure from the communication system selection part 185 instructs the communication system selection part 185 of start of the trial acquisition processing by an 1x(O) stored in the scan list storage part 187 (S217).

The communication system selection part 185 receives this, selects an 1x(O) stored in the scan list storage part 187, instructs the 1x protocol execution part 184 of acquisition for making the 1x protocol execution part execute acquisition by the 1x communication system selected here, and waits for the notification of whether the acquisition is possible (S218). The 1x protocol execution part 184 executes the trial acquisition processing by the selected 1x(O) with the base station 20 and notifies the result of whether the acquisition is possible to the communication system selection part 185. When the success of acquisition is notified (S218 “success”), the communication system selection part 185 activates the acquisition instruction function execution part 186 and the acquisition instruction function execution part 186 executes the send processing using the successfully acquired 1x communication system (S219).

On the other hand, when the acquisition fails (S218 “failure”), the communication system selection part 185 judges whether or not there is an alternative 1x(O) again with reference to the scan list storage part 187 (S220).

Here, when there is an alternative 1x communication system (S220 “Yes”), the communication system selection part 185 selects that alternative 1x communication system (S221), instructs the 1x protocol execution part 184 of acquisition for making the 1x protocol execution part execute the acquisition by the 1x communication system selected here, and waits for the notification of whether the acquisition is possible (S218).

Then, when the trial acquisition processing of all communication systems by the alternative 1x(O)s is executed and the acquisition fails in all (S218 “failure”), the 1x protocol execution part notifies the failure of sending to a client (S222).

The acquisition instruction function execution part 186 receives the notification of failure of sending, controls the display control part 182, and displays a message (icon is possible too) showing the failure of sending on the display part 16.

According to the second send processing (2) described above, by selecting a communication system existing in the success history considered to have a high sending success rate with a higher priority irrespective of whether the communication protocol is the EVDO communication system or 1x communication system (a 1x communication system which has succeeded in the trial acquisition processing is processed with a higher priority than the EVDO communication system which has not succeeded in the trial acquisition processing), the time from the request of sending up to the send processing is shortened, and the opportunity of sending increases, therefore the usability can be improved.

Namely, there are many cases where almost no time has passed from the transition to the “out-of-service-area” to when the send request occurs or a user does not move much at all, therefore, it is not necessarily preferred that all communication systems be subjected to the trial acquisition processing according to a prescribed sequence according to the PRL at the time of the sending in the “out-of-service-area” state.

In such a case, the peripheral signal environment is frequently approximately the same as the state immediately before the transition to “out-of-service-area”, therefore there is a good possibility that a communication system sufficiently capable of a sending operation will be found by only trial acquisition processing according to the MRU continuously updating the storage of the history of successfully acquired communication systems up to immediately before the transition to the “out-of-service-area” state. In particular, when determining an acquisition candidate according to the MRU, even when the failure continues for EVDO communication systems, the trial acquisition is further carried out for the 1x communication systems as well, therefore a system having a success history is acquired with a higher priority irrespective of the EVDO/1x.

Further, even when the trial acquisition processing based on the MRU fails, the trial acquisition processing for other communication systems is continuously carried out based on the PRL while omitting overlapping trial acquisition processing. For this reason, for one series of communication systems, the trial acquisition processing can be carried out without increasing the required time.

Further, in a case where the time for continuing the send processing from the start of sending is restricted or the like, by selecting a communication system considered to have a high sending success rate with a high priority and executing the trial acquisition processing, the sending success rate can be raised.

Note that, according to the embodiment of the present invention described above, a mobile phone was exemplified as the wireless communication terminal, but the same effects are obtained even when the invention is applied to a PDA (Personal Digital Assistant), PC (Personal Computer), or game machine.

Further, the functions of the constituent blocks of the wireless communication terminal according to the present embodiment may all be realized by software or at least a portion may be realized by hardware. For example, the processing in the control part 18 and the data processing in the communication part 11 and the speech processing part 13 may be realized in a computer by one or more programs. Further, at least a portion may be realized by hardware as well.

Note that, according to the above embodiments, an example of using EVDO and 1x as communication protocols was explained, but the present invention is not limited to this. Needless to say, the present invention can be applied to a wireless communication terminal using another communication protocol as well.

### INDUSTRIAL APPLICABILITY

According to the present invention, even in the state judged “out-of-service-area”, the communication system is efficiently acquired when the send processing occurs and connection by the communication scheme desired by the user can be achieved as much as possible, therefore the invention can be applied to a mobile phone or other wireless communication terminal suitable for use for a multiband compatible wireless communication system.

1. A wireless communication terminal comprising:
a communication part capable of capturing a plurality of communication systems and capable of executing communication by a communication protocol;
a control part which controls communication by the communication part by any of the plurality of communication systems using the communication protocol when the start of communication is instructed; and
a memory part,
wherein
the memory part stores information specifying a successfully acquired communication system among the plurality of communication systems as a success history, and
the control part
performs a trial acquisition by the communication part using the communication system specified in the success history as a target for acquisition when a start of communication is requested in a state judged as an “out-of-service-area” state where the communication cannot be carried out,
if the trial acquisition fails, performs a further trial acquisition by the communication part using a communication system not specified in the success history among the plurality of communication systems as the target for acquisition, and
starts the communication when one of said trial acquisition by the communication part succeeds.

2. A wireless communication terminal as set forth in claim 1, wherein
the memory part stores a plurality of cases of information specifying communication systems successfully acquired by the communication part in an order of successful acquisition as the success history, and
the control part sequentially determines the communication systems specified in the success history as the target for acquisition from the newest one when making the communication part execute the trial acquisition based on the success history.

3. A wireless communication terminal as set forth in claim 1, wherein
the control part comprises:
a communication system selection part instructing the communication part of a communication system to be acquired,
a protocol execution part instructing the communication part of acquisition by the communication protocol, and
an acquisition instruction function execution part instructing the communication system selection part of a start of trial acquisition processing of the communication system, and
the acquisition instruction function execution part makes the communication system selection part select a communication system which does not exist in the success history among the plurality of communication systems and makes the protocol execution part instruct the acquisition of the selected communication system when the start of communication is requested in a state judged as an “out-of-service-area” state and the trial acquisition of the communication system specified by the information stored in the success history fails.

4. A wireless communication terminal as set forth in claim 3, wherein
the control part stores several cases as the success history in an order of successful acquisition for communication systems successfully acquired by the communication part, and
the communication system selection part sequentially selects communication systems specified by the success history from the newest one when selecting the target for acquisition based on the success history.

5. A wireless communication terminal as set forth in claim 3, wherein
the communication protocol includes a first communication protocol and a second communication protocol,
the protocol execution part includes
a first protocol execution part instructing the communication part of acquisition by the first communication protocol, and
a second protocol execution part instructing the communication part of acquisition by the second communication protocol with a lower degree of priority for the trial acquisition processing than the first communication protocol, and
wherein
the acquisition instruction function execution part makes the first protocol execution part instruct the acquisition of the selected communication system and makes the communication system selection part select the communication system based on the success history when the start of communication is requested in the state “out-of-service-area”, while
makes the communication system selection part select the communication system based on the success history and makes the second protocol execution part instruct the acquisition of the selected communication system when the trial acquisition of the communication system based on the success history by the first protocol execution part fails.

6. A wireless communication terminal as set forth in claim 5, wherein
the acquisition instruction function execution part
makes the communication system selection part select a communication system not specified by the success history among the plurality of communication systems and makes the first protocol execution part instruct the acquisition of the selected communication system when the start of the communication is requested in the out-of-service-area state and both of the first protocol execution part and the second protocol execution part fail in the trial acquisition of the communication system selected based on the success history, and
makes the communication system selection part select the communication system based on the success history and makes the second protocol execution part instruct the acquisition of the selected communication system when the trial acquisition of the communication system not specified by the success history by the first protocol execution part fails.

7. A wireless communication terminal as set forth in claim 6, wherein
the memory part stores the information showing the successfully acquired communication system and information showing by which of the first protocol execution part or second protocol execution part the acquisition was successful when storing the success history, and
the acquisition instruction function execution part
makes the communication system selection part select the communication system successfully acquired by the first protocol execution part, and
makes the first protocol execution part instruct the acquisition when the start of the communication is requested in the “out-of-service-area” state and the communication system is to be selected based on the success history by the communication system selection part, and
makes the communication system selection part select the communication system successfully acquired by the second protocol execution part and makes the second protocol execution part instruct the acquisition of the selected communication system when the trial acquisition fails for the selected communication system.

8. A communication control method of a wireless communication terminal comprising a communication part capable of capturing a plurality of communication systems and capable of executing communication by a communication protocol and a memory part and controlling the communication by the communication part by any of the plurality of communication systems using the communication protocol when the start of communication is instructed,
said communication control method of a wireless communication terminal comprising:
a step of storing information specifying a successfully acquired communication system among the plurality of communication systems as the success history in the memory part;
a step of having the communication part perform a trial acquisition using the communication system specified by the success history as the target for acquisition when the start of communication is requested in a state judged as “out-of-service-area” where communication cannot be carried out;
a step of having the communication part perform the trial acquisition using a communication system not specified by the success history among the plurality of communication systems as the target for acquisition where the trial acquisition fails; and
a step of starting the communication when the trial acquisition by the communication part succeeds.

9. A communication control method of a wireless communication terminal as set forth in claim 8, further comprising
having the memory part store a plurality of cases of information specifying a communication system successfully acquired by the communication part as the success history in an order of successful acquisition and
sequentially determines a target for acquisition from the newest one among communication systems specified by the success history when making the communication part execute a trial acquisition based on the success history.

10. A wireless communication system comprising:
a base station; and
a wireless communication terminal performing wireless communication with the base station through a channel assigned by the base station, wherein
the wireless communication terminal has
a communication part capable of capturing a plurality of communication systems and capable of executing communication according to a communication protocol,
a control part which controls communication by the communication part by any of the plurality of communication systems using the communication protocol when a start of communication is instructed, and
a memory part,
the memory part stores information specifying a successfully acquired communication system among the plurality of communication systems as the success history, and
the control part
performs the trial acquisition by the communication part using the communication system specified by the success history as the target for acquisition when the start of communication is instructed in the state judged as the “out-of-service-area” state where the communication cannot be carried out, performs the trial acquisition by the communication part using a communication system not specified by the success history among the plurality of communication systems as the target for acquisition when the trial acquisition fails, and
starts the communication when the trial acquisition by the communication part succeeds.
